(19) United States
(12) Patent Application Publication
(10) Pub. No.: US 2001/0007273 A1
(43) Pub. Date: Jul. 12, 2001

(54) SEALING FILMS TO TRAYS

(76) Inventor: MICHAEL P. GORLICH, HILTON HEAD, SC (US)

Correspondence Address: HOVEY, WILLIAMS, TIMMONS & COLLINS, 2405 GRAND BLVD., SUITE 400, KANSAS CITY, MO, 64108, US

(21) Appl. No.: 09/177,741

(22) Filed: Oct. 23, 1998

(51) Int. Cl. B32B 31/00

(52) U.S. Cl. 156/308.4

(57) ABSTRACT

A film may be sealed to a tray by flattening an upper edge of the tray to produce a planar sealing surface. A film may then be sealed to the planar sealing surface. The flattening may be achieved using a high temperature heat sealing apparatus and may cause closure of the cells of open-cell foam trays. In addition, the heat used in the flattening step may be useful in facilitating the heat sealing of the film to the tray if done in sufficiently quick succession.

### BACKGROUND

This invention relates generally to sealing films to trays made of plastic or foam.

In a number of applications, it is desirable to seal a film material such as a plastic, paper or foil film to a tray made of plastic, foam or other heat sealable materials.

In many cases, it would be desirable to produce a leak resistant seal between the film and the tray. However, in some cases it is difficult or impossible to produce a consistent, leak-proof seal between the tray and the film. Thus, many trays such as foam trays generally are not closed by sealing a film to the tray upper edges. Instead, the tray is simply overwrapped with a plastic material which adheres to the tray.

However, there is a continuing need for a technique which would facilitate sealing films to such trays.

### SUMMARY

In accordance with one embodiment, a method of sealing a film to a tray having an upper edge includes flattening the upper edge of the tray. A film is then sealed to the flattened upper edge of the tray.

### BRIEF DESCRIPTION OF THE DRAWINGS

FIG. 1 is a perspective view of a tray in accordance with the prior art;

FIG. 2 is an enlarged, partial, cross-sectional view taken generally along the line 2-2 in FIG. 1;

FIG. 3 is an enlarged, cross-sectional view taken generally along the line 3-3 in FIG. 1;

FIG. 4 is an enlarged, cross-sectional view of one embodiment of the invention in the course of flattening the upper edge of the tray;

FIG. 5 is an enlarged, cross-sectional view of the tray after the flattening shown in FIG. 4;

FIG. 6 is an enlarged, cross-sectional view of the tray in FIG. 5 with a film positioned over the tray;

FIG. 7 is an enlarged, cross-sectional view of the tray shown in FIG. 6 with the film in the course of being sealed to the tray;

FIG. 8 is an enlarged, cross-sectional view of the tray shown in FIG. 7 with excess film being severed; and

FIG. 9 is a enlarged, cross-sectional view of one embodiment of the invention after the film has been sealed to a tray.

### DETAILED DESCRIPTION

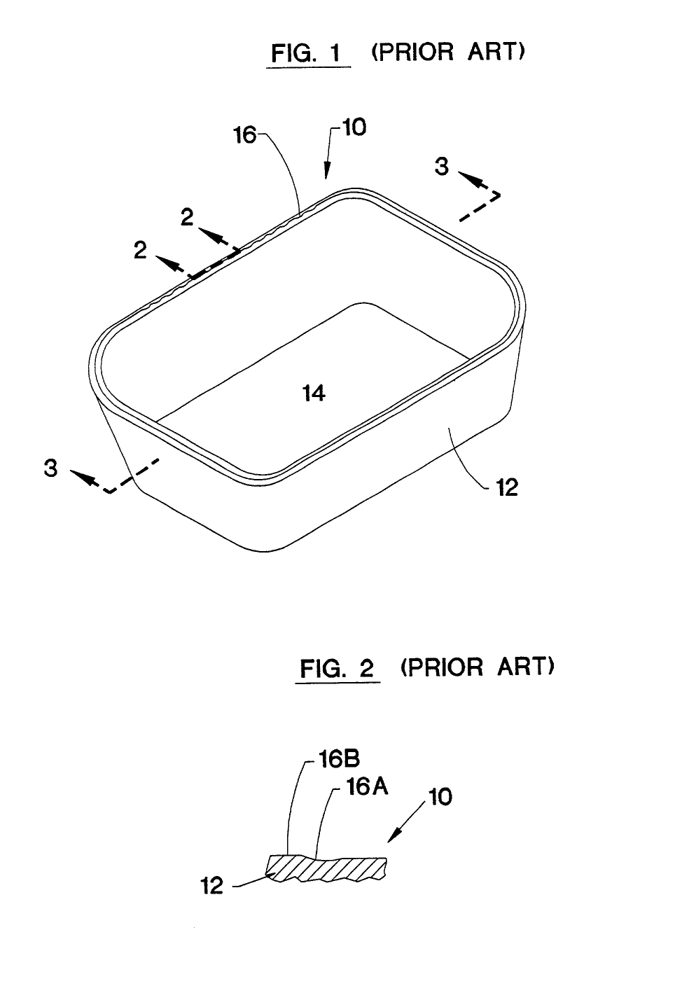

A conventional packaging tray which may be used for packaging a variety of items including meat, is shown in FIG. 1. The tray includes a plurality of sides 12 and a bottom 14. The tray may also include an upper edge 16, which as shown in FIG. 2, may be irregular. That is, the tray upper edge 16 may not lie entirely within a single plane. Therefore, sealing film to the tray may be difficult because the low regions 16a, shown in FIG. 2, may not be properly sealed even if the raised regions 16b are properly sealed.

The tray 10 may be made of a variety of materials including foam such as polystyrene foam. The tray may also be made of other plastic film materials such as the relatively rigid plastic film materials used to make packaging trays. In all of these cases, the upper edge of the tray may be irregular, at least in some cases, causing difficulties in obtaining a leak-proof seal between the film and the tray.

The film may be a heat sealable plastic film, a heat sealable foil or paper laminate film or any other film that may be used in closing packaging trays.

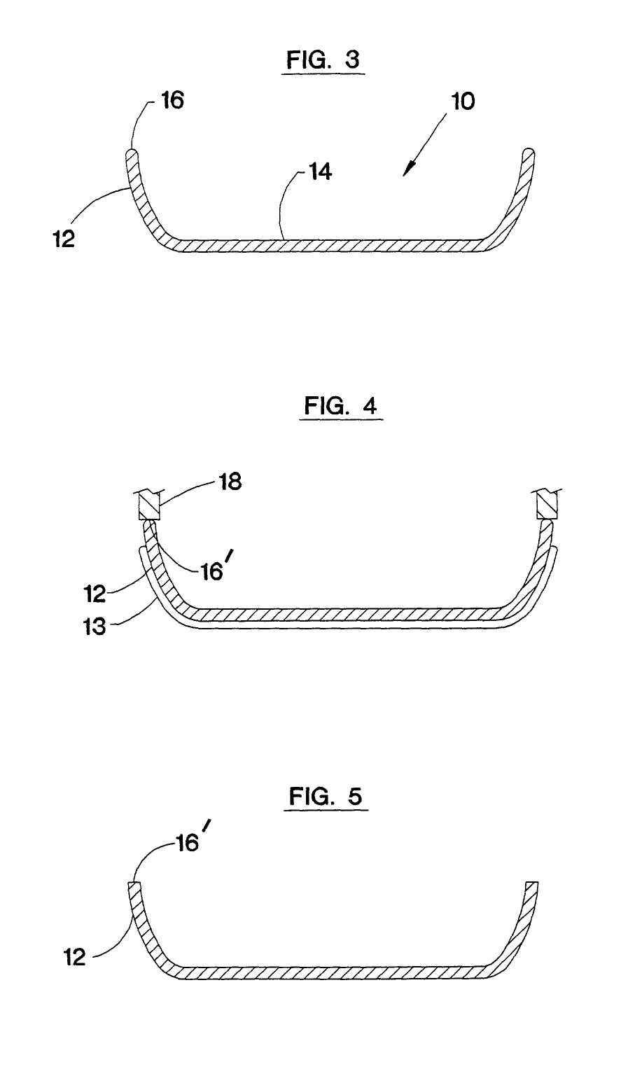

Referring now to FIG. 3, in at least some embodiments, and particularly in those where foam trays are involved, the upper edge 16 of the tray may be formed in a rounded bead shape. Thus, relatively little space is provided to facilitate sealing the film to the tray. This combined with the possibility of irregularities in the upper surface 16 makes it difficult in many cases to seal the film to the tray reliably.

Referring to FIG. 4, a conventional heat sealing tool may be applied to the upper edge 16 to form a flattened upper edge 16′ as shown in FIG. 4. If desired, the tray may be supported using a conforming or partially conforming tray holder 13. The tool 18 may have a lower edge which is generally planar and produces a relatively planar, flattened upper edge 16′ around the entire periphery of the tray 10. The heat sealing tool may apply sufficient temperature to soften the material forming the upper edge.

It may be advantageous in embodiments wherein a food product is contained within the tray 10 to avoid having the heat sealing tool 18 overlap excessively over the interior of the tray. This could cause cooking of a food product in the tray. Thus, in some embodiments, the inner edge of the sealing bar 23 may be substantially aligned with the inner edge of a side 12.

As shown in FIG. 5, the flattened edge 16 provides an ideal sealing surface. In addition, in connection with open cell foam trays, the softening of the foam may tend to close the open cell foam used to make the tray. This results in a better seal between a film cover and the tray. Advantageously, the sealing bar 18 has a non-stick surface.

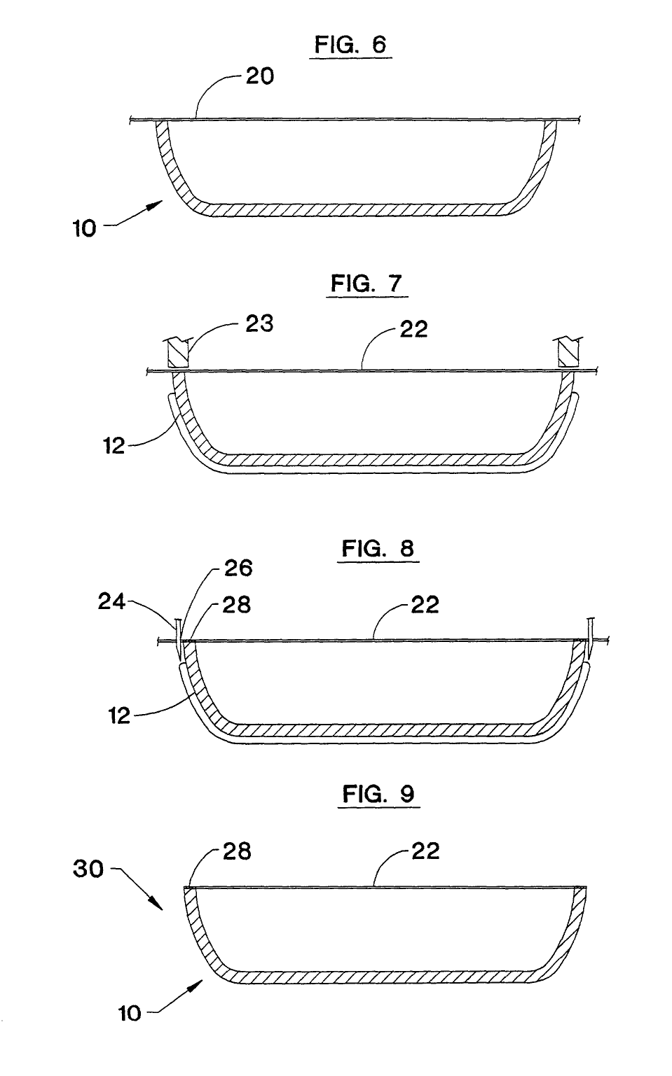

Referring now to FIG. 6, a covering film 20 is then applied over the tray 10. The film may be secured by heat sealing, for example, to the tray 10 as indicated in FIG. 7 using the seal bar 23.

The resulting structure, as shown in FIG. 8, includes the film 22 sealed at 28 to the side edges 12 of the tray 10 at the flattened upper edge 16′. Thereafter, the excess film is severed from the rest of the tray using a severing device 24. The severing device may use heat, for example.

The finished package 30, shown in FIG. 9, may include a seal 28 which connects an overlying film 22 to the tray 10. The reliability of that seal may be enhanced because of the flattening of the upper edge of the tray. This flattening provides a planar sealing surface which may be reliably sealed using high speed equipment. In addition, the flattening may close cells, in the case of open cell foam trays, resulting in a better seal.

Moreover, the residual heat applied in the step shown in FIG. 4 may be used to facilitate the sealing of the film to the tray 10, as shown in FIG. 7. That is, the residual heat in the tray 10 may facilitate the high speed sealing of the film 22 to the tray 10 if the sealing is done close enough in time to the flattening of the upper edge.

While the present invention has been described with respect to a limited number of embodiments, those skilled in the art will appreciate numerous modifications and variations therefrom. It is intended that the appended claims cover those variations that fall within the true spirit and scope of the present invention.

What is claimed is:

1. A method of sealing a film to a tray having an upper edge comprising:
flattening the upper edge of the tray; and
sealing a film to the flattened upper edge of the tray.

2. The method of claim 1 wherein said tray is a open-cell foam tray and wherein flattening closes the cells of the upper edge of the foam tray.

3. The method of claim 1 including flattening the upper edge of the tray into substantially a common plane.

4. The method of claim 1 including heat sealing said film to said flattened upper edge.

5. The method of claim 4 including sealing said film to said flattened upper edge while said upper edge is still heated from said flattening step.

6. The method of claim 1 wherein flattening includes using a heated bar.

7. The method of claim 6 wherein flattening includes avoiding heating the interior contents of the tray.

8. The method of claim 7 wherein flattening further includes providing a heating bar that does not extend substantially over the interior of the tray.

9. A package formed by a process comprising:
flattening the upper edge of the tray; and
sealing a film to the flattened upper edge of the tray.

10. The package of claim 9 formed of an open cell foam tray.

11. The package of claim 10 wherein the foam cells are closed along said upper edge.

12. The package of claim 9 wherein said upper edge is substantially planar.

13. A method of sealing a film to a tray having an upper edge comprising:
heating the upper edge of said tray;
placing a film over said heated upper edge; and
sealing said film to said heated upper edge.

14. The method of claim 13 including sealing said film using the residual heat from heating the upper edge.

15. The method of claim 13 wherein said tray is a open-cell foam tray and including closing the cells of the upper edge of the foam tray by heating the upper edge.

16. The method of claim 13 including flattening the upper edge into substantially a common plane.

17. The method of claim 13 including heat sealing said film to said upper edge.

18. The method of claim 17 including heating the upper edge so as to avoid heating the interior contents of the tray.

19. The method of claim 18 including using a heating bar that does not extend substantially over the interior of the tray to heat said upper edge.

20. The method of claim 13 including heating said edge sufficiently to soften said upper edge.
